(19) United States
(12) Patent Application Publication
(10) Pub. No.: US 2026/0142400 A1
(43) Pub. Date: May 21, 2026

(54) CONNECTOR

(71) Applicant: SUMITOMO WIRING SYSTEMS, LTD., Mie (JP)

(72) Inventors: Hiroki KATO, Mie (JP); Temma FUJIOKA, Mie (JP)

(21) Appl. No.: 19/377,915

(22) Filed: Nov. 3, 2025

(30) Foreign Application Priority Data
Nov. 15, 2024 (JP) 2024-199630

(51) Int. Cl. H01R 13/434

(52) U.S. Cl. CPC H01R 13/434

(57) ABSTRACT

A retainer is disposed in a mounting hole of a housing, and moves in the left-right direction from a temporary locking position to a final locking position. A body portion of the retainer is disposed with a clearance between the body portion and a front hole surface of the mounting hole at the temporary locking position. A forward protrusion (end-side forward protrusions and an intermediate forward protrusion) of the retainer is opposed to the front hole surface of the mounting hole so as to be contactable therewith at the temporary locking position. A rear hole surface of the mounting hole includes a pressing portion configured to press forward the retainer moving from the temporary locking position to the final locking position.

### CROSS-REFERENCE TO RELATED APPLICATIONS

This application is based on and claims priority from Japanese Patent Application No. 2024-199630, filed on Nov. 15, 2024, with the Japan Patent Office, the disclosure of which is incorporated herein in its entirety by reference.

### TECHNICAL FIELD

The present disclosure relates to a connector.

### BACKGROUND

The connector disclosed in JP 2022-191827 A includes a terminal, a housing configured to accommodate the terminal, and a side retainer (hereinafter referred to as a “retainer”) configured to be mounted to the housing. The retainer is configured to be moved in the left-right direction between a temporary locking position and a final locking position relative to the housing. The retainer includes an elastically deformable lance. The lance is opposed to the terminal so as to be lockable thereto from behind at each of the temporary locking position and the final locking position.

### SUMMARY

When the retainer is at the final locking position, a clearance due to assembling tolerance, dimensional tolerance, and the like is formed between the terminal and the lance. If a large clearance is formed between the terminal and the lance, the stability of locking of the retainer to the terminal is impaired, resulting in such a problem that the stability of a connection state between the terminal and a counterpart terminal, for example, is also impaired.

Therefore, an object of the present disclosure is to provide a connector that can ensure the stability of locking of a retainer to a terminal.

A connector according to the present disclosure is a connector including: a housing; a retainer; and a terminal, wherein the housing includes a cavity extending in a front-rear direction, and a mounting hole intersecting the cavity, the retainer is disposed so as to be movable relative to the housing in a direction intersecting the front-rear direction between a temporary locking position and a final locking position while being disposed in the mounting hole, the terminal is disposed in the cavity, and suppressed from being dislodged rearward from the cavity by the retainer located at the final locking position, the retainer includes a body portion disposed with a clearance between the retainer and a front hole surface of the mounting hole at the temporary locking position, and a forward protrusion protruding forward from the body portion, the forward protrusion is opposed to the front hole surface of the mounting hole so as to be contactable therewith at the temporary locking position, a rear hole surface of the mounting hole includes a pressing portion configured to press forward the retainer moving from the temporary locking position to the final locking position, and the front hole surface of the mounting hole includes a recess configured to accommodate the forward protrusion at the final locking position of the retainer.

According to the present disclosure, it is possible to provide a connector that can ensure the stability of locking of a retainer to a terminal.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exploded perspective view of a connector according to Embodiment 1 of the present disclosure.

FIG. 2 is a cross-sectional side view showing a state in which a terminal accommodated in a housing is locked to a lance of a retainer in the connector according to Embodiment 1 of the present disclosure.

FIG. 3 is a side view of the connector according to Embodiment 1 of the present disclosure, showing the housing as viewed from one lateral side.

FIG. 4 is a horizontal cross-sectional view of the connector according to Embodiment 1 of the present disclosure, showing the housing cut along an intermediate portion in the up-down direction.

FIG. 5 is a perspective view of the connector according to Embodiment 1 of the present disclosure, showing the retainer as viewed from the front.

FIG. 6 is a plan view of the retainer of the connector according to Embodiment 1 of the present disclosure.

FIG. 7 is a side view of the retainer of the connector according to Embodiment 1 of the present disclosure.

FIG. 8 is a transverse sectional view of the connector according to Embodiment 1 of the present disclosure, cut along a position corresponding to the lance when the retainer is disposed at a temporary locking position relative to the housing.

FIG. 9 is a transverse sectional view of the connector according to Embodiment 1 of the present disclosure, cut along a position corresponding to the lance when the retainer is disposed at a final locking position relative to the housing.

FIG. 10 is an enlarged horizontal cross-sectional view of the connector according to Embodiment 1 of the present disclosure, cut along a position corresponding to an upper end portion of the retainer when the retainer is disposed at the temporary locking position relative to the housing.

FIG. 11 is an enlarged horizontal cross-sectional view of the connector according to Embodiment 1 of the present disclosure, cut along a position corresponding to an upper end portion of the retainer when the retainer is disposed at the final locking position relative to the housing.

FIG. 12 is an enlarged side view of the connector according to Embodiment 1 of the present disclosure, showing a portion of the retainer that is accommodated in the housing as viewed from one lateral side when the retainer is disposed at the temporary locking position relative to the housing.

FIG. 13 is an enlarged side view of the connector according to Embodiment 1 of the present disclosure, showing a portion of the retainer that is accommodated in the housing as viewed from the one lateral side when the retainer is disposed at the temporary locking position relative to the housing.

FIG. 14 is a side view of the connector according to Embodiment 1 of the present disclosure, showing the connector as viewed from the other lateral side when the retainer is disposed at the final locking position relative to the housing.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, embodiments of the present disclosure will be listed and described.
(1) A connector according to the present disclosure is a connector including: a housing; a retainer; and a terminal, wherein the housing includes a cavity extending in a front-rear direction, and a mounting hole intersecting the cavity, the retainer is disposed so as to be movable relative to the housing in a direction intersecting the front-rear direction between a temporary locking position and a final locking position while being disposed in the mounting hole, the terminal is disposed in the cavity, and suppressed from being dislodged rearward from the cavity by the retainer located at the final locking position, the retainer includes a body portion disposed with a clearance between the retainer and a front hole surface of the mounting hole at the temporary locking position, and a forward protrusion protruding forward from the body portion, the forward protrusion is opposed to the front hole surface of the mounting hole so as to be contactable therewith at the temporary locking position, a rear hole surface of the mounting hole includes a pressing portion configured to press forward the retainer moving from the temporary locking position to the final locking position, and the front hole surface of the mounting hole includes a recess configured to accommodate the forward protrusion at the final locking position of the retainer.

Since the retainer is pressed forward by the pressing portion in the process in which the retainer moves from the temporary locking position to the final locking position, the clearance between the retainer and the terminal is reduced. Accordingly, it is possible to ensure the stability of locking of the retainer to the terminal. When the retainer is at the temporary locking position, there is a clearance between the body portion of the retainer and the front hole surface of the mounting hole. However, the forward protrusion is opposed to the front hole surface of the mounting hole so as to be contactable therewith. Accordingly, the retainer can be disposed inside the mounting hole without rattling. When the retainer is at the final locking position, the forward protrusion is allowed to escape into the recess. Accordingly, it is possible to avoid interference between the forward protrusion and the housing, thus making it possible to prevent an increase in assembly resistance of the retainer moving to the final locking position.
(2) In the connector according to (1) above, it is preferable that the retainer includes a rearward protrusion protruding rearward from the body portion, and the rearward protrusion is opposed to the rear hole surface of the mounting hole so as to be contactable therewith at the final locking position.

If the forward protrusion is allowed to escape into the recess when the retainer is at the final locking position, there is a concern that a clearance may be formed between the body portion and the rear hole surface of the mounting hole. However, with the configuration according to (2) above, the rearward protrusion is opposed to the rear hole surface of the mounting hole at the final locking position so as to be contactable therewith. Accordingly, the retainer can be disposed inside the mounting hole without rattling also at the final locking position.
(3) In the connector according to (1) or (2) above, it is preferable that the mounting hole includes an insertion opening that is open on one side surface of the housing, and an amount of exposure of the forward protrusion from the insertion opening is decreased from the temporary locking position to the final locking position.

With the configuration according to (3) above, after performing the operation of moving the retainer to the final locking position, the degree of decrease in the amount of exposure of the forward protrusion is checked through the insertion opening. Thus, it is possible to detect whether the retainer has properly moved to the final locking position.
(4) In the connector according to any one (1) to (3) above, it is preferable that the mounting hole is provided so as to extend from the insertion opening to an inner end surface located near another side surface of the housing, and a window hole in communication with the mounting hole is open on the other side surface of the housing, and the forward protrusion is disposed so as to face the window hole at the final locking position.

With the configuration according to (4) above, after performing the operation of moving the retainer to the final locking position, whether the forward protrusion is visible through the window hole is checked. Thus, it is possible to detect that the retainer has been properly moved to the final locking position.
(5) In the connector according to any one of (1) to (4) above, it is preferable that the retainer includes an elastically deformable lance that is opposed to the terminal from behind at each of the temporary locking position and the final locking position, and the lance is in contact with the terminal at the final locking position.

As a result of the lance being in contact with the terminal at the final locking position, the terminal is accommodated in the cavity without rattling. For example, when the terminal is a shield terminal configured to be connected to a shielded wire, it is possible to improve the shielding performance.

### Details of Embodiments of the Present Disclosure

Specific examples of the present disclosure will be described below with reference to the drawings. It should be noted that the present invention is not limited to these examples, but indicated by the claims, and is intended to include all modifications which fall within the scope of the claims and the meaning and scope of equivalents thereof.

### (Embodiment 1)

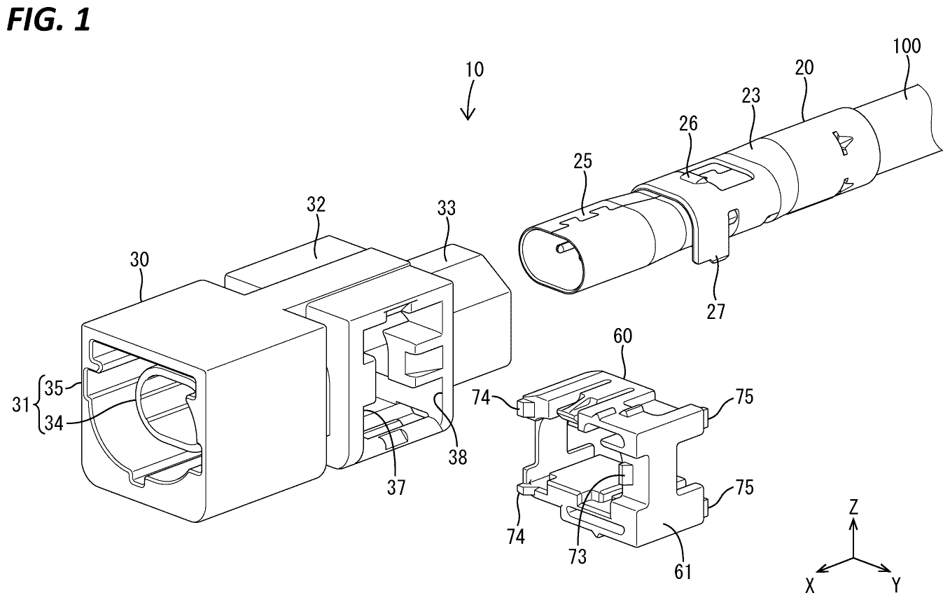

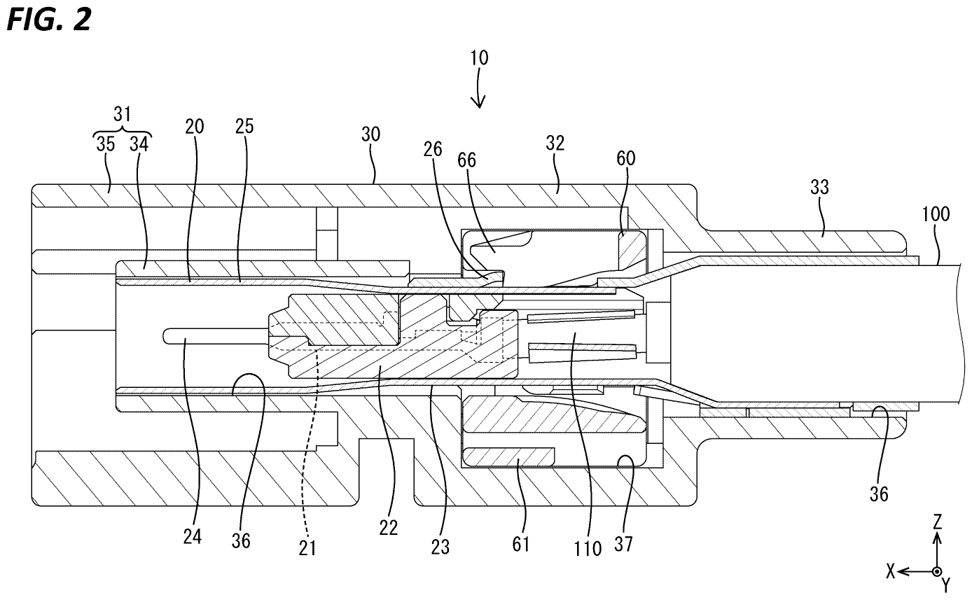

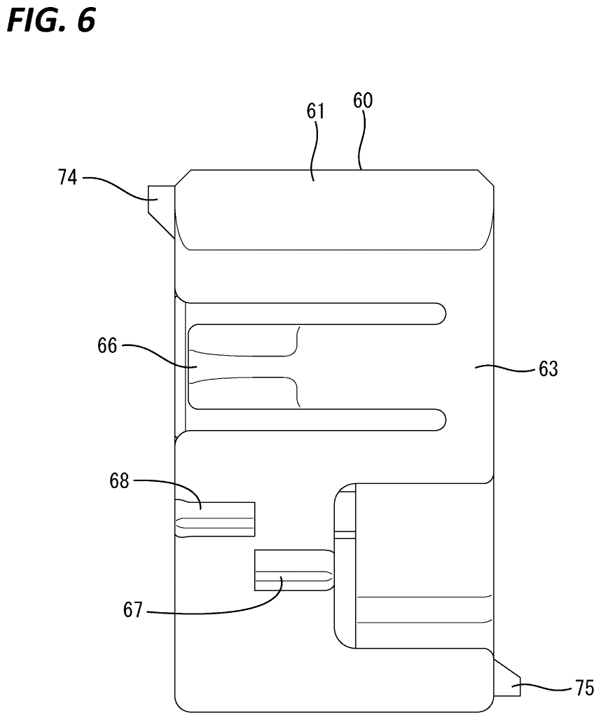

A connector 10 according to Embodiment 1 includes a terminal 20, a housing 30 configured to accommodate the terminal 20, and a retainer 60 configured to be mounted to the housing 30. The terminal 20 is a so-called shield terminal, and is connected to a terminal portion of a shielded wire 100. The housing 30 fits to a counterpart connector (not shown). In the following description, as for the front-rear direction, the side on which the housing 30 fits to the counterpart connector is defined as the front side. The up-down direction is defined with respect to the up-down direction of the drawings excluding FIGS. 6, 10, and 11. Reference characters X, Y, and Z in FIGS. 1 and 2 respectively indicate the front side, the right side, and the upper side. The directions are defined for the sake of convenience, and do not necessarily coincide with the corresponding directions in a state in which the connector 10 is mounted in a vehicle or the like (not shown).

### (Terminal)

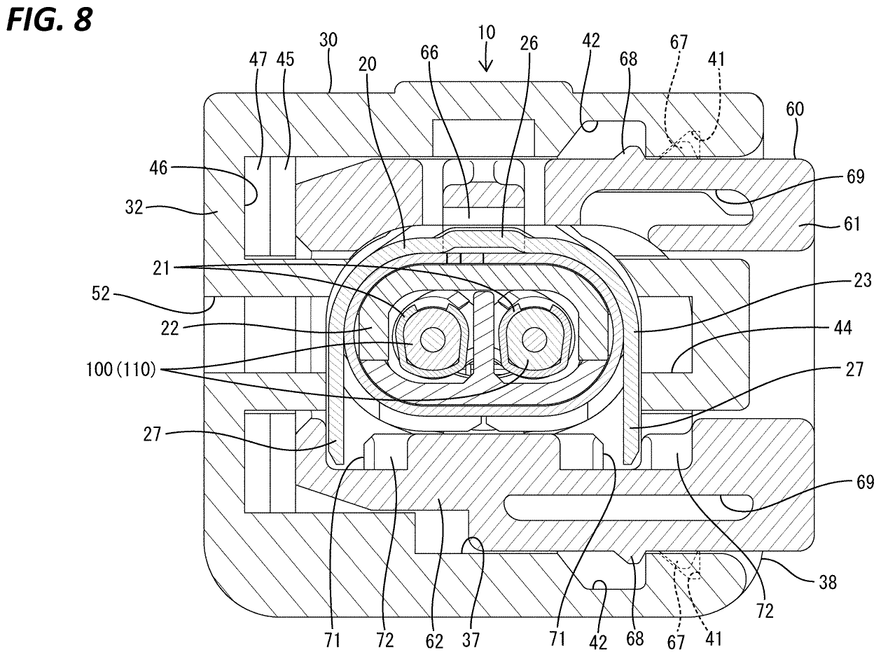

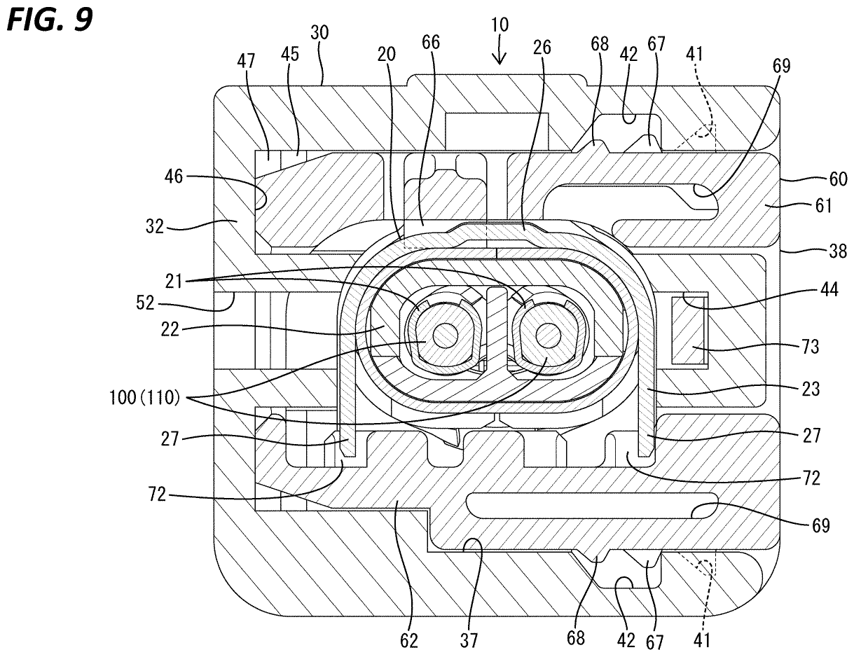

As shown in FIG. 2, the terminal 20 includes inner conductors 21, a dielectric 22 configured to accommodate the inner conductors 21, and an outer conductor 23 configured to surround the dielectric 22. The inner conductors 21 and the outer conductor 23 are both made of a conductive metal. The dielectric 22 is made of synthetic resin (insulating resin). The dielectric 22 maintains an insulation state between the outer conductor 23 and the inner conductors 21. As shown in FIGS. 8 and 9, a pair of inner conductors 21 are accommodated inside the dielectric 22 in the left-right direction, and are connected to coated wires 110 (twisted pair wires or the like) of the shielded wire 100 through crimping. As shown in FIG. 2, each of the inner conductors 21 includes a male tab 24 at the front. The outer conductor 23 includes a tubular portion 25 located forward of the dielectric 22. The male tab 24 protrudes from the dielectric 22 into to the tubular portion 25.

The outer conductor 23 includes a locking projection 26 that protrudes upward. The locking projection 26 has a pawl shape, and is formed by cutting and raising (bending and raising) a portion of an upper wall of the outer conductor 23. As shown in FIGS. 8 and 9, the locking projection 26 is configured such that a lance 66, which will be described later, of the retainer 60 can be locked thereto. The outer conductor 23 includes a pair of left and right projecting piece portions 27 that protrude downward. As shown in FIG. 1, the projecting piece portions 27 have a plate shape extending along the front-rear direction, and are formed by downward protruding portions of left and right side walls of the outer conductor 23. As shown in FIG. 9, the projecting piece portions 27 are locked to retaining portions 72, which will be described later, of the retainer 60.

### (Housing)

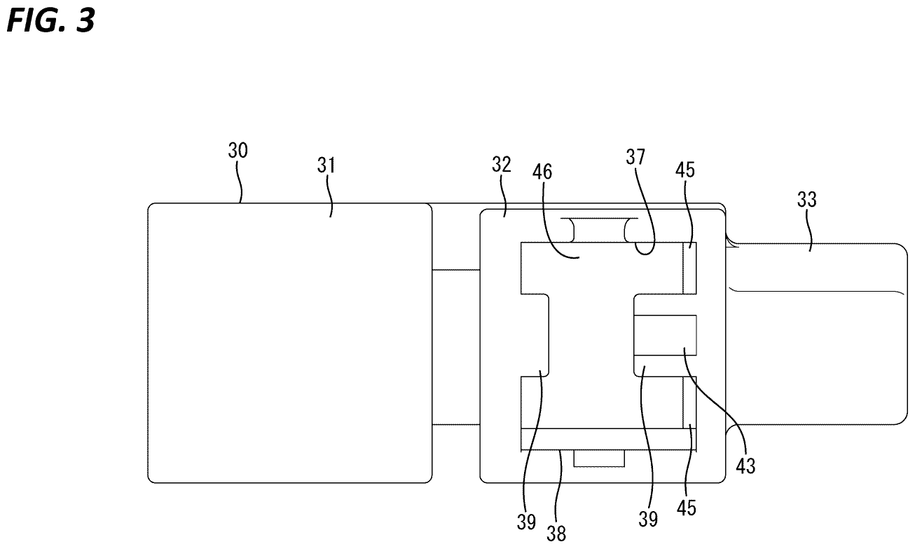

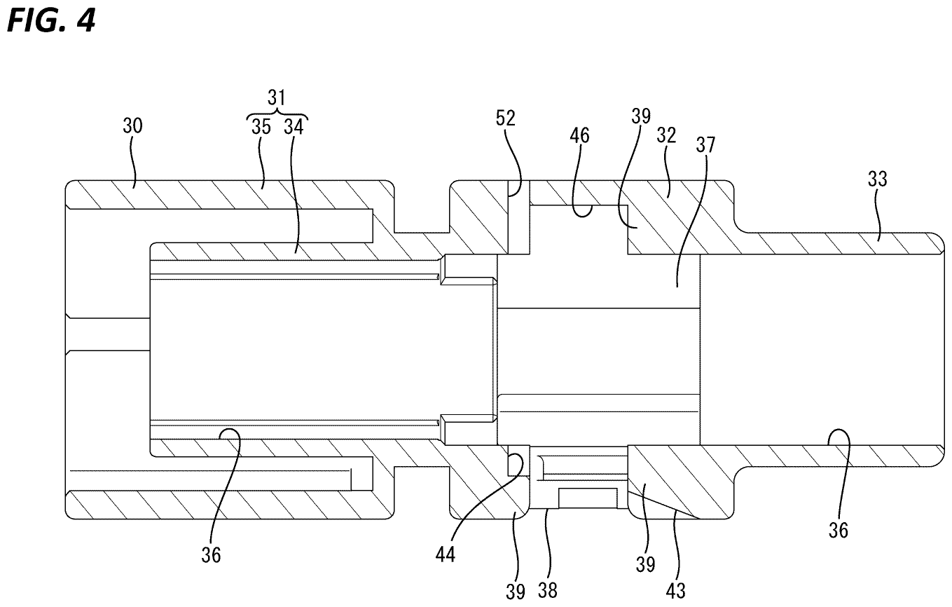

The housing 30 is made of synthetic resin. As shown in FIGS. 3 and 4, the housing 30 is composed of a fitting portion 31, a housing body 32, and a rear tube portion 33 that are sequentially connected from the front side to the rear side. As shown in FIG. 1, all of the fitting portion 31, the housing body 32, and the rear tube portion 33 have a quadrangular outer shape. Each of the fitting portion 31 and the housing body 32 is formed to be one size larger than the rear tube portion 33.

The fitting portion 31 includes a front tube portion 34, and a hood portion 35 that surrounds the outer periphery of the front tube portion 34. A counterpart housing of the counterpart connector (not shown) is fitted and inserted between the hood portion 35 and the front tube portion 34. Although a lock portion capable of locking the counterpart housing during fitting is formed on an upper wall of the hood portion 35, the illustration of the lock portion has been omitted.

As shown in FIG. 4, the front tube portion 34 and the rear tube portion 33 each have a cavity 36 extending in the front-rear direction. The housing body 32 includes a mounting hole 37 intersecting the cavities 36. The terminal 20 is accommodated so as to extend from the cavity 36 of the front tube portion 34 to the mounting hole 37. The terminal portion of the shielded wire 100 is accommodated in the cavity 36 of the rear tube portion 33.

As shown in FIGS. 1 and 3, the mounting hole 37 includes an insertion opening 38 that is open on one side surface (right side surface) of the housing body 32. As shown in FIGS. 4, 8 and 9, the mounting hole 37 extends in the housing body 32 in the left-right direction from the insertion opening 38 to an inner end surface 46 located near the other side surface (left side surface). The retainer 60 is inserted into the mounting hole 37 from one lateral side (right side) of the housing body 32 through the insertion opening 38.

As shown in FIGS. 8 and 9, on each of upper and lower hole surfaces (downwardly facing surface and upwardly facing surface) of the mounting hole 37, a first locking receiving portion 41 and a second locking receiving portion 42 are recessed so as to be arranged side by side in the left-right direction. The first locking receiving portion 41 is disposed toward the one lateral side relative to the second locking receiving portion 42. The opening width of the second locking receiving portion 42 in the left-right direction is larger than the opening width of the first locking receiving portion 41 in the left-right direction. A first locking portion 67 and a second locking portion 68, which will be described later, of the retainer 60 are configured to be fitted to the first locking receiving portion 41 and the second locking receiving portion 42.

As shown in FIG. 3, the mounting hole 37 has a hole width in the front-rear direction that is smaller at an intermediate portion in the up-down direction than at opposite end portions in the up-down direction, and has an H-shape (inverted H-shape) in a side view. The housing body 32 includes, at the intermediate portion in the up-down direction of the mounting hole 37, a pair of intermediate bulged portions 39 that are bulged inward in the front-rear direction. The intermediate bulged portions 39 are opposed to each other so as to be spaced apart in the front-rear direction with the intermediate portion in the up-down direction of the mounting hole 37 interposed therebetween. As shown in FIG. 4, an intermediate slope portion 43 that is inclined inward in the left-right direction (toward the other lateral side) toward the front side is formed on the one side surface of the rear intermediate bulged portion 39. An intermediate recess 44 extending in the left-right direction is formed on a rear surface (surface opposed to the rear intermediate bulged portion 39) of the front intermediate bulged portion 39.

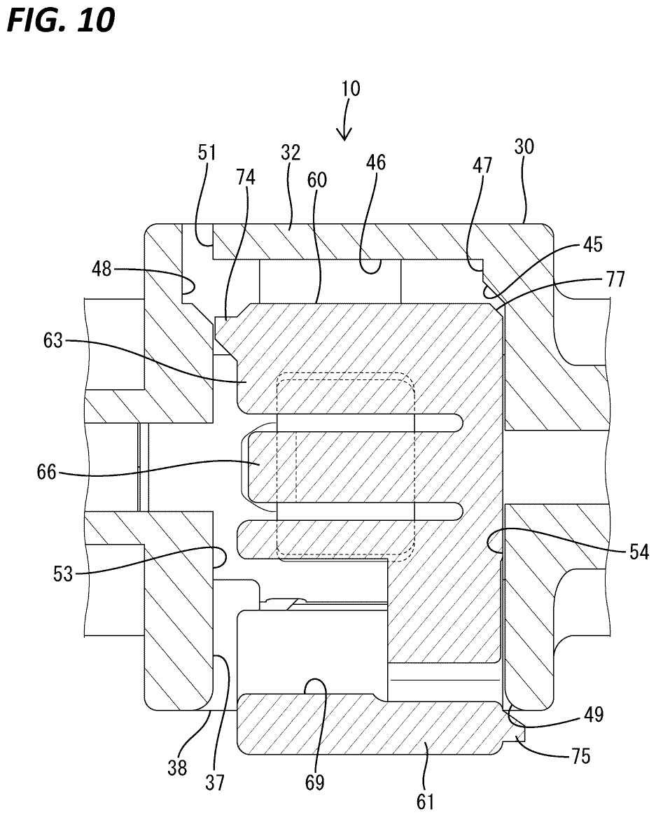

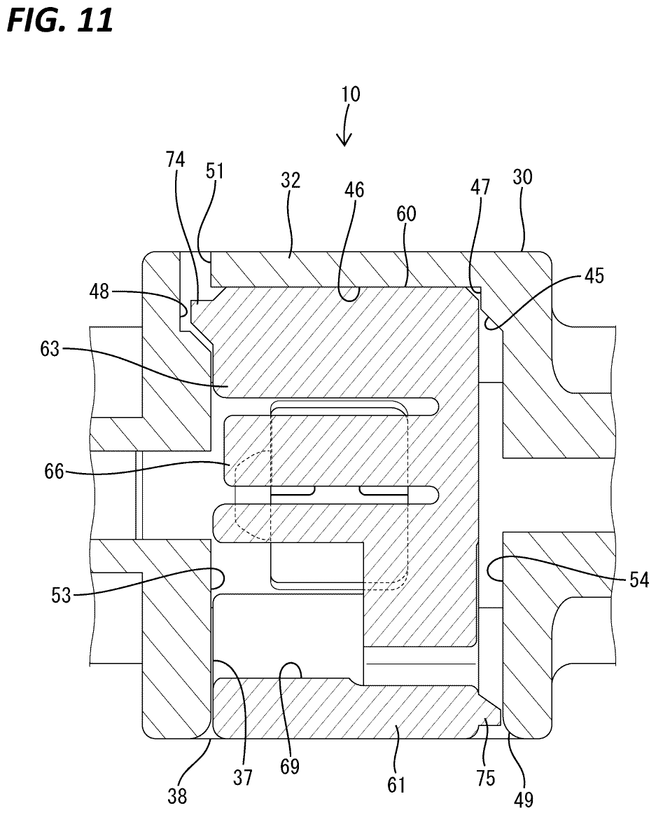

As shown in FIGS. 10 and 11, a front hole surface (rearwardly facing surface) at each of the opposite end portions, in the up-down direction, of the mounting hole 37 of the housing body 32, except for an end-side recess 48 and so forth, which will be described later, constitutes a front wall surface 53 disposed along the left-right direction. A rear hole surface (forward facing surface) at each of the opposite end portions, in the up-down direction, of the mounting hole 37 of the housing body 32, except for a pressing portion 45 and so forth, which will be described later, constitutes a rear wall surface 54 disposed along the left-right direction. Note that a front hole surface and a rear hole surface at the intermediate portion, in the up-down direction, of the mounting hole 37 of the housing body 32 also constitute wall surfaces corresponding to the front wall surface 53 and the rear wall surface 54, respectively.

As shown in FIGS. 3, 10, and 11, pressing portions 45 in the form of a slope inclined forward toward the other lateral side are formed on the rear wall surface 54 of the mounting hole 37. The pressing portions 45 are disposed in the vicinity of the inner end surface 46 of the mounting hole 37. As shown in FIGS. 10 and 11, a straight surface portion 47 extending along the left-right direction is formed between the inner end surface 46 and each of the pressing portions 45 of the mounting hole 37. As will be described later, the pair of upper and lower pressing portions 45 serve the function of pressing forward the retainer 60 moving to the final locking position.

As shown in FIGS. 10 and 11, an end-side recess 48 is recessed on the front wall surface 53 of the mounting hole 37. The end-side recess 48 is opposed to the corresponding pressing portion 45 and the corresponding straight surface portion 47 in the front-rear direction at a position near the inner end surface 46 of the mounting hole 37. One side surface (surface facing another direction) of the end-side recess 48 is in the form of a slope inclined forward toward the other lateral side.

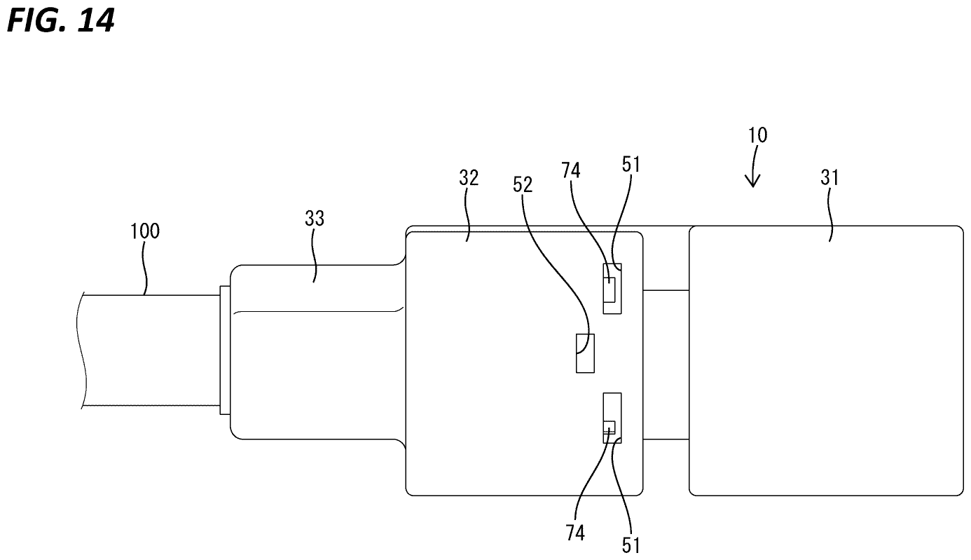

As shown in FIG. 14, a pair of upper and lower end-side window holes 51, and an intermediate window hole 52 located between the end-side window holes 51 in the up-down direction are open on the other side surface of the housing body 32. The end-side window holes 51 are each in the form of a slit hole extending in the up-down direction, and are in communication with the corresponding end-side recesses 48 (see FIGS. 10 and 11). The intermediate window hole 52 is also in the form of a slit hole extending in the up-down direction, and is in communication with the intermediate recess 44 (see FIG. 4). The intermediate window hole 52 is disposed forward of the end-side window holes 51 in the front-rear direction. The end-side window holes 51 are disposed at the same position in the front-rear direction.

### (Retainer)

The retainer 60 is made of synthetic resin. The retainer 60 is configured to be moved in the left-right direction between a temporary locking position (see FIGS. 8 and 10) and a final locking position (see FIGS. 9 and 11) relative to the housing 30 while being inserted in the mounting hole 37.

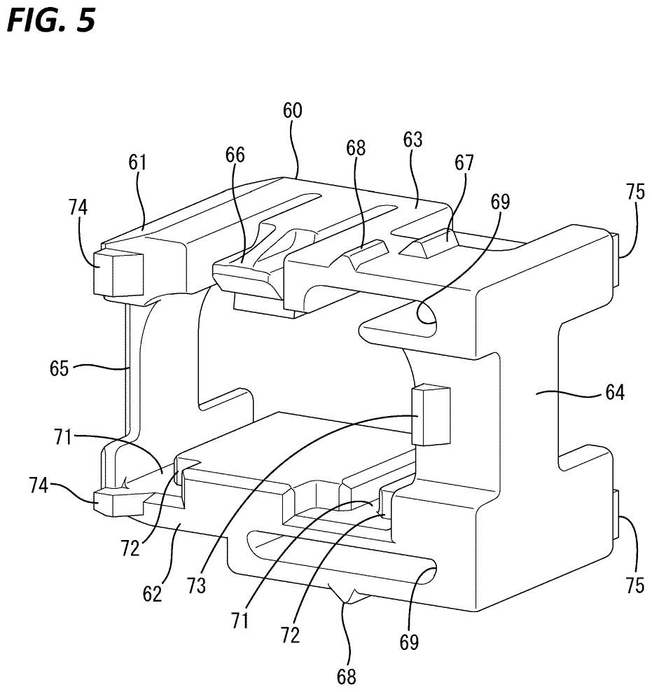

As shown in FIG. 5, the retainer 60 includes a body portion 61 having the shape of a quadrangular frame in a front view. The body portion 61 has an H-shape (inverted H-shape) in a side view. As shown in FIG. 10, when the retainer 60 is at the temporary locking position, the body portion 61 is opposed to the rear wall surface 54 of the mounting hole 37 so as to be contactable therewith, and is disposed away from the front wall surface 53 of the mounting hole 37. As shown in FIG. 11, when the retainer 60 is at the final locking position, the body portion 61 is opposed to the front wall surface 53 of the mounting hole 37 so as to be contactable therewith, and is disposed away from the rear wall surface 54 of the mounting hole 37.

As shown in FIG. 5, the body portion 61 includes a lower wall 62, an upper wall 63, and a pair of left and right side walls 64 and 65 connecting the lower wall 62 and the upper wall 63 to each other. Each of the side walls 64 and 65 extends along the up-down direction so as to span between the respective intermediate portions of a lower surface of the lower wall 62 and an upper surface of the upper wall 63 in the front-rear direction. Of the pair of left and right side walls 64 and 65, one side wall 64 located on one lateral side has a larger thickness in the left-right direction than the other side wall 65 located on the other lateral side.

A lance 66 is formed on the upper wall 63 of the body portion 61. The lance 66 is formed so as to be elastically deformable in a pair of left and right notches formed in a portion of the upper wall 63 of the body portion 61. The lance 66 has a shape extending in the front-rear direction in the notches, and is elastically deformable in the up-down direction with a rear end portion of the body portion 61 serving as a support point.

A first locking portion 67 and a second locking portion 68 are formed on each of the upper surface of the upper wall 63 and the lower surface of the lower wall 62 of the body portion 61 so as to protrude side by side in the left-right direction. Each of the first locking portion 67 and the second locking portion 68 has the shape of a rib extending in the front-rear direction. As shown in FIGS. 5 and 6, the first locking portion 67 is disposed at a position located rearward and toward one lateral side relative to the second locking portion 68. As shown in FIG. 5, a deflection allowing space 69 that allows elastic deformation of the first locking portion 67 and the second locking portion 68 are formed on each of the upper wall 63 and the lower wall 62 of the body portion 61. On the upper wall 63 of the body portion 61, the first locking portion 67, the second locking portion 68, and the deflection allowing space 69 are disposed side by side with the lance 66 at a position located toward one lateral side relative to the lance 66.

A pair of left and right escaping grooves 71 are formed on an upper surface of the lower wall 62 of the body portion 61. The escaping grooves 71 extend in the front-rear direction, and are disposed spaced apart from each other in the left-right direction. In the process of inserting the terminal 20, the projecting piece portions 27 are allowed to escape into the corresponding escaping grooves 71 (see FIG. 8). In addition, a pair of left and right retaining portions 72 are formed on the upper surface of the lower wall 62 of the body portion 61 at positions adjacent to the corresponding escaping grooves 71. The retaining portions 72 each have a perpendicular front surface facing forward at an intermediate portion of the lower wall 62 of the body portion 61 in the front-rear direction. When the retainer 60 is at the final locking position, the front surfaces of the retaining portions 72 are opposed to rear ends of the corresponding projecting piece portions 27 so as to be contactable therewith, and the terminal 20 is suppressed from being dislodged from the cavities 36 (see FIG. 9).

As shown in FIG. 5, the retainer 60 includes an intermediate forward protrusion 73 protruding forward from a front surface of the one side wall 64. The intermediate forward protrusion 73 extends in a predetermined cross-sectional shape (trapezoidal cross-sectional shape) in the up-down direction. One side surface of the intermediate forward protrusion 73 is in the form of a slope inclined to the other lateral side toward the front side. A distal end surface (front end surface) of the intermediate forward protrusion 73 is disposed perpendicularly along the up-down direction. As shown in FIG. 9, when the retainer 60 is at the final locking position, the intermediate forward protrusion 73 is allowed to escape into intermediate recess 44.

As shown in FIG. 5, the retainer 60 includes a pair of upper and lower end-side forward protrusions 74 protruding forward from front surfaces of the other end portions of the upper wall 63 and the lower wall 62. The end-side forward protrusions 74 each extend in a predetermined cross-sectional shape (trapezoidal cross-sectional shape) in the up-down direction. The dimension of the lower end-side forward protrusion 74 in the up-down direction is smaller than the dimension of the upper end-side forward protrusion 74 in the up-down direction. One side surface of each of the end-side forward protrusions 74 is in the form of a slope inclined to the other lateral side toward the front side. A distal end surface (front end surface) of each of the end-side forward protrusions 74 is disposed perpendicularly along the up-down direction. As shown in FIG. 11, when the retainer 60 is at the final locking position, the end-side forward protrusions 74 are allowed to escape into the corresponding end-side recesses 48.

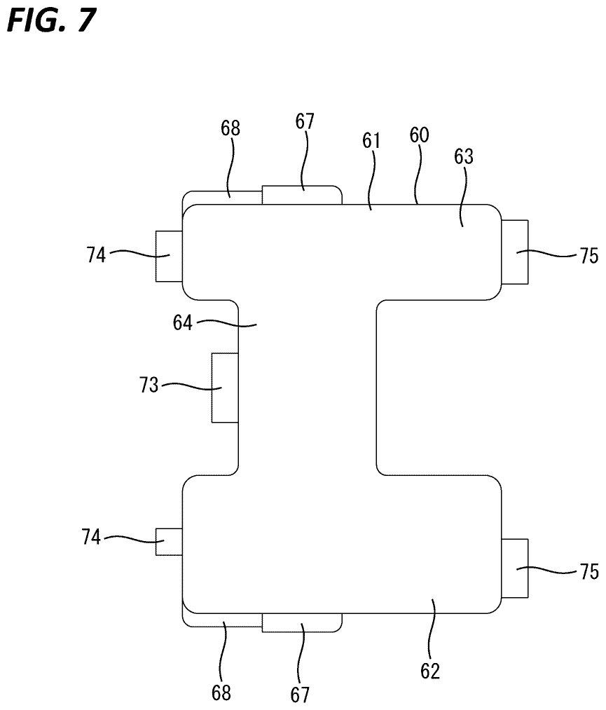

As shown in FIGS. 5 and 7, the retainer 60 includes a pair of upper and lower end-side rearward protrusions 75 protruding rearward from rear surfaces of one end portions of the upper wall 63 and the lower wall 62. The end-side rearward protrusions 75 each extend in a predetermined cross-sectional shape (trapezoidal cross-sectional shape) in the up-down direction. The end-side rearward protrusions 75 are configured to have the same shape and the same size. The other side surface of each of the end-side rearward protrusions 75 is in the form of a slope inclined to the other side surface side toward the front. A distal end surface (rear end face) of each of the end-side forward protrusions 74 is disposed perpendicularly along the up-down direction. As shown in FIG. 11, when the retainer 60 is at the final locking position, the distal end surfaces of the end-side rearward protrusions 75 are opposed to the rear wall surface 54 of the mounting hole 37 so as to be contactable therewith.

### (Operations of Connector)

In assembling, the retainer 60 is inserted into the mounting hole 37 from the insertion opening 38 of the housing 30. In the process of inserting the retainer 60, the other side wall 65 of the body portion 61 enters the intermediate portion, in the up-down direction, of the mounting hole 37 that is formed so as to have a smaller width in the front-rear direction between the intermediate bulged portions 39. As shown in FIG. 8, as a result of the second locking portions 68 elastically fitting into the corresponding second locking receiving portions 42, and the first locking portions 67 elastically fitting into the corresponding first locking receiving portions 41, the retainer 60 is held at the temporary locking position relative to the housing 30. When the retainer 60 is at the temporary locking position, one end portion of the body portion 61 is disposed so as to protrude toward the one lateral side from the insertion opening 38 of the housing 30.

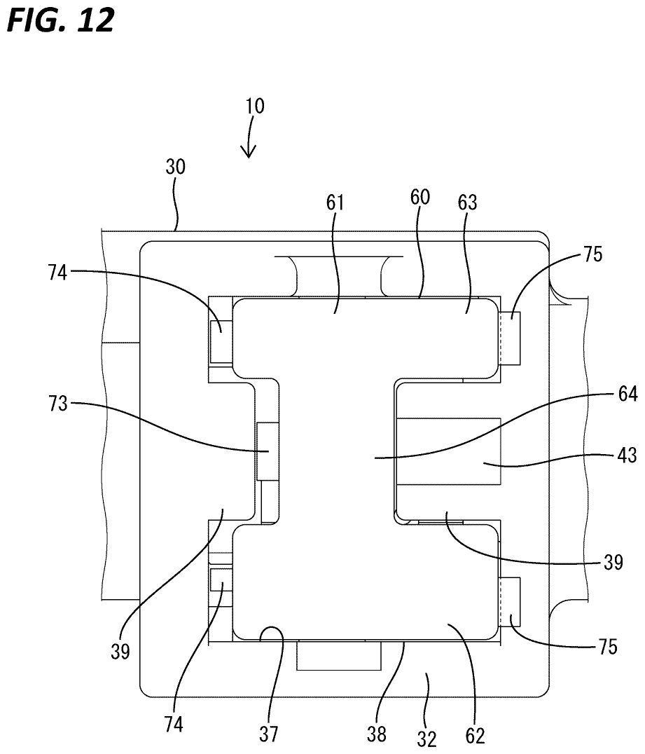

As shown in FIG. 12, when the retainer 60 is at the temporary locking position, the rear surfaces of the upper wall 63 and the lower wall 62 of the body portion 61 are opposed to the rear wall surface 54 of the mounting hole 37 so as to be contactable therewith. Furthermore, at the temporary locking position, the distal end surface of the intermediate forward protrusion 73 is opposed to the front hole surface at the intermediate portion, in the up-down direction, of the mounting hole 37 so as to be contactable therewith, and the distal end surfaces of the end-side forward protrusions 74 are opposed to the front wall surface 53 of the mounting hole 37 so as to be contactable therewith. Thus, the retainer 60 is held so as to be suppressed from rattling relative to the housing 30 at the temporary locking position. As shown in FIG. 10, the other side surface of each of the end-side rearward protrusion 75 is opposed to a chamfered portion 49 formed on one side end of the rear wall surface 54 of the mounting hole 37 so as to be contactable therewith. As shown in FIG. 12, when the retainer 60 is at the temporary locking position, all of the end-side forward protrusions 74 and the intermediate forward protrusion 73 are disposed such that the entire one side surfaces thereof are visible through the insertion opening 38. The end-side rearward protrusions 75 are disposed such that the entire one side surfaces thereof are visible on the front side of the chamfered portions 49.

In the above-described state, the terminal 20 is inserted into the cavities 36 of the housing 30 from behind. In the process of inserting the terminal 20, the locking projection 26 interferes with the lance 66, and the lance 66 is elastically deformed upward. After the insertion of the terminal 20 has been completed, the lance 66 elastically returns, and the distal end surface of the lance 66 is disposed rearward of the locking projection 26 so as to be lockable thereto (see FIG. 8). At this time, a clearance may be formed between the lance 66 and the locking projection 26 in the front-rear direction. The projecting piece portions 27 are disposed side by side with the corresponding retaining portions 72 so as to be located forward of the corresponding escaping grooves 71 and toward the other lateral side relative to the corresponding retaining portions 72.

Subsequently, the retainer 60 is pressed toward the other lateral side, and moved toward the final locking position. In the process in which the retainer 60 moves to the final locking position, rounded-off slope portions 77 (see FIG. 10) formed on a rear surface of another end portion (a distal end portion of the retainer 60 in the direction of movement to the final locking position) of the body portion 61 slide along the corresponding pressing portions 45, whereby a pressing force for pressing the retainer 60 forward is imparted to the retainer 60 moving toward the other lateral side. Consequently, the retainer 60 is moved obliquely forward relative to the left-right direction. While the retainer 60 is moved obliquely forward, the one side surfaces of the end-side forward protrusions 74 slide along the one side surfaces of the corresponding end-side recesses 48, and the other side surfaces of the end-side rearward protrusions 75 slide along the corresponding chamfered portions 49 of the mounting hole 37.

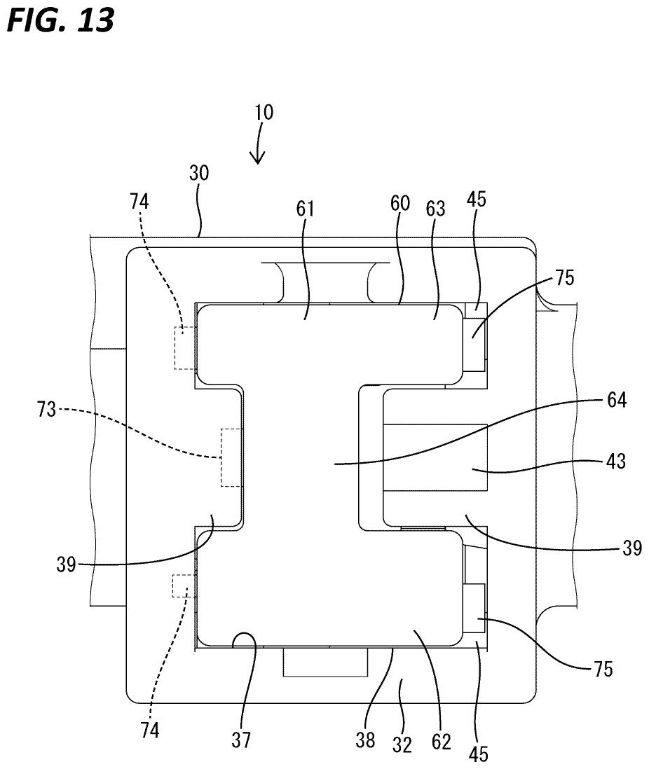

As a result of the retainer 60 being moved obliquely forward by the pressing portions 45, the clearance between the lance 66 and the locking projection 26 is reduced. While the retainer 60 reaches the final locking position, the distal end surface of the lance 66 comes into contact with the locking projection 26, and the lance 66 presses the locking projection 26 forward. As shown in FIG. 9, when the retainer 60 reaches the final locking position, the first locking portions 67 also elastically fit into the corresponding second locking receiving portions 42, and the other side surface of the body portion 61 abuts against the inner end surface 46 of the mounting hole 37. Thus, the retainer 60 is held at the final locking position relative to the housing 30. When the retainer 60 is at the final locking position, the entire body portion 61 is accommodated inside the mounting hole 37. At the final locking position, as shown in FIG. 13, the front surfaces of the upper wall 63 and the lower wall 62 of the body portion 61 are opposed to the front wall surface 53 of the mounting hole 37 so as to be contactable therewith. The end-side rearward protrusions 75 are opposed to a portion of the rear wall surface 54 of the mounting hole 37 that is located near the one lateral side so as to be contactable therewith. The end-side forward protrusions 74 enter the corresponding end-side recesses 48, and are prevented from interfering with the housing body 32 (see FIG. 11). The intermediate forward protrusion 73 also enters the intermediate recess 44, and is prevented from interfering the housing body 32. Thus, the retainer 60 is held so as to be suppressed from rattling relative to the housing 30 at the final locking position.

When the retainer 60 is at the final locking position, the end-side forward protrusions 74 are disposed so as to face the corresponding end-side window holes 51 from the one lateral side. As shown in FIG. 14, the operator can detect that the retainer 60 has reached the final locking position by viewing the end-side forward protrusions 74 through the corresponding end-side window holes 51 from the other lateral side.

In the process in which the retainer 60 moves from the temporary locking position to the final locking position, the amounts of exposure of the end-side forward protrusions 74 and the intermediate forward protrusion 73 that face the insertion opening 38 decrease as shown in FIGS. 12 to 13. As shown in FIG. 13, when the retainer 60 reaches the final locking position, the amounts of exposure of the end-side forward protrusions 74 and the intermediate forward protrusion 73 become zero, and the operator no longer can view the end-side forward protrusions 74 and the intermediate forward protrusion 73 from the one lateral side through the insertion opening 38. Accordingly, it is possible to detect that the retainer 60 has reached the final locking position also by the fact that the end-side forward protrusions 74 and the intermediate forward protrusion 73 become not visible from the one lateral side.

When the retainer 60 is at the final locking position, in addition to the locking state (contacting state) between the distal end surface of the lance 66 and the locking projection 26 being maintained (see FIG. 2), the retaining portions 72 are opposed to the corresponding projecting piece portions 27 so as to be contactable therewith from behind (see FIG. 9). Thus, the terminal 20 is reliably held so as to be suppressed from being dislodged from the cavities 36 relative to the housing 30. In addition, the terminal 20 is suppressed from rattling by the lance 66, and it is therefore possible to improve the shielding performance.

As described thus far, the connector 10 according to Embodiment 1 includes the housing 30, the retainer 60, and the terminal 20. The housing 30 includes the cavities 36 extending in the front-rear direction, and the mounting hole 37 intersecting the cavities 36. The retainer 60 is disposed so as to be movable in the left-right direction intersecting the front-rear direction between the temporary locking position and the final locking position relative to the housing 30 while being disposed in the mounting hole 37. The terminal 20 is disposed in the cavities 36, and is suppressed from being dislodged rearward from the cavities 36 by the retainer 60 located at the final locking position. The retainer 60 includes the body portion 61 disposed with a clearance between the retainer 60 and the front wall surface 53 (front hole surface) of the mounting hole 37 at the temporary locking position, and the end-side forward protrusions 74 and the intermediate forward protrusion 73 (forward protrusions) protruding forward from the body portion 61. The end-side forward protrusions 74 and the intermediate forward protrusion 73 are opposed to the front wall surface 53 of the mounting hole 37 so as to be contactable therewith at the temporary locking position. The rear wall surface 54 (rear hole surface) of the mounting hole 37 includes the pressing portions 45 configured to press forward the retainer 60 moving from the temporary locking position to the final locking position. The front wall surface 53 of the mounting hole 37 includes the end-side recesses 48 and the intermediate recess 44 (recesses) configured to accommodate the end-side forward protrusions 74 and the intermediate forward protrusion 73 at the final locking position of the retainer 60.

Since the retainer 60 is pressed forward by the pressing portions 45 in the process in which the retainer 60 moves from the temporary locking position to the final locking position, the clearance between the retainer 60 and the terminal 20 is reduced. Accordingly, it is possible to ensure the stability of locking of the retainer 60 to the terminal 20. When the retainer 60 is at the temporary locking position, there is a clearance between the body portion 61 of the retainer 60 and the front wall surface 53 of the mounting hole 37. However, the end-side forward protrusions 74 and the intermediate forward protrusion 73 are opposed to the front wall surface 53 of the mounting hole 37 (more specifically, the intermediate forward protrusion 73 is the front hole surface at the intermediate portion, in the up-down direction, of the mounting hole 37) so as to be contactable therewith. Accordingly, the retainer 60 can be disposed inside the mounting hole 37 without rattling. When the retainer 60 is at the final locking position, the end-side forward protrusions 74 and the intermediate forward protrusion 73 are allowed to escape into the end-side recesses 48 and the intermediate recess 44. Accordingly, it is possible to avoid interference with the housing 30, thus making it possible to prevent an increase in assembly resistance of the retainer 60 moving to the final locking position.

In the case of Embodiment 1, the retainer 60 includes the end-side rearward protrusions 75 (rearward protrusions) protruding rearward from the body portion 61, and the end-side rearward protrusions 75 are opposed to the rear wall surface 5(rear hole surface) of the mounting hole 37 so as to be contactable therewith at the final locking position. Since the end-side rearward protrusions 75 are opposed to the rear wall surface 54 of the mounting hole 37 so as to be contactable therewith at the final locking position, the retainer 60 can be disposed inside the mounting hole 37 also at the final locking position without rattling.

In the case of Embodiment 1, the mounting hole 37 includes the insertion opening 38 that is open on one side surface of the housing 30, and the amounts of exposure of the end-side forward protrusions 74 and the intermediate forward protrusion 73 (forward protrusions) from the insertion opening 38 are decreased from the temporary locking position to the final locking position. After performing the operation of moving the retainer 60 to the final locking position, the degree of decrease in the amounts of exposure (in the case of Embodiment 1, the amounts of exposure are zero) of the end-side forward protrusions 74 and the intermediate forward protrusion 73 is checked through the insertion opening 38. Thus, it is possible to detect whether the retainer 60 has properly moved to the final locking position.

Furthermore, in the case of Embodiment 1, the mounting hole 37 is formed so as to extend from the insertion opening 38 that is open on one side surface of the housing 30 to the inner end surface 46 located near the other side surface of the housing 30, and the end-side window holes 51 (window holes) in communication with the mounting hole 37 are open on the other side surface of the housing 30. The end-side forward protrusions 74 (forward protrusions) are disposed so as to face the end-side window holes 51 at the final locking position. Accordingly, after performing the operation of moving the retainer 60 to the final locking position, whether the end-side forward protrusions 74 are visible through the end-side window holes 51 is checked. Thus, it is possible to more reliably detect that the retainer 60 has been properly moved to the final locking position.

Furthermore, the retainer 60 includes the elastically deformable lance 66 that is opposed to the terminal 20 from behind at each of the temporary locking position and the final locking position. Since the lance 66 is in contact with the terminal 20 at the final locking position, the terminal 20 is accommodated in the cavities 36 without rattling. In particular, in the case of Embodiment 1, the terminal 20 is a shield terminal configured to be connected to the shielded wire 100, and it is therefore possible to improve the shielding performance.

### Other Embodiments of the Present Disclosure

It should be appreciated that Embodiment 1 presently disclosed is in all respects illustrative and not limiting.

In the case of Embodiment 1 above, the pressing portions are formed in a slope shape on the rear wall surface of the mounting hole. In contrast, according to other embodiments, the pressing portions may be formed in a stepped shape rather than a slope shape on the rear wall surface of the mounting hole. For example, it is possible to adopt a configuration in which the slope portions of the retainer slide against the pressing portions having a stepped shape, whereby the retainer is moved forward.

In the case of Embodiment 1 above, the retainer is provided with the rearward protrusions. In contrast, according to other embodiments, the retainer need not be provided with the rearward protrusions.

In the case of Embodiment 1 above, the retainer is provided with the lance. In contrast, according to other embodiments, the retainer need not be provided with the lance. For example, it is possible to adopt a configuration in which, when the retainer is at the final locking position, the front surfaces of the retaining portions come into contact with the projecting piece portions of the terminal.

In the case of Embodiment 1 above, the terminal is a shield terminal connected to a shielded wire. In contrast, according to other embodiments, the terminal may be a general terminal that is connected to a general wire and is entirely made of a conductive metal.

In the case of Embodiment 1 above, the forward protrusions include the end-side forward protrusions and the intermediate forward protrusion. In contrast, according to other embodiments, the forward protrusions may include either the end-side forward protrusions or the intermediate forward protrusion.

In the case of Embodiment 1 above, the amounts of exposure of the forward protrusions from the insertion opening become zero at the final locking position. In contrast, according to other embodiments, the forward protrusions may be exposed so as to be visible at the final locking position. Simply put, it is sufficient that the operator can confirm the degree of decrease in the amounts of exposure of the forward protrusions through the insertion opening.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a housing; a retainer; and a terminal, wherein
the housing includes a cavity extending in a front-rear direction, and a mounting hole intersecting the cavity,
the retainer is disposed so as to be movable relative to the housing in a direction intersecting the front-rear direction between a temporary locking position and a final locking position while being disposed in the mounting hole,
the terminal is disposed in the cavity, and suppressed from being dislodged rearward from the cavity by the retainer located at the final locking position,
the retainer includes a body portion disposed with a clearance between the retainer and a front hole surface of the mounting hole at the temporary locking position, and a forward protrusion protruding forward from the body portion,
the forward protrusion is opposed to the front hole surface of the mounting hole so as to be contactable therewith at the temporary locking position,
a rear hole surface of the mounting hole includes a pressing portion configured to press forward the retainer moving from the temporary locking position to the final locking position, and
the front hole surface of the mounting hole includes a recess configured to accommodate the forward protrusion at the final locking position of the retainer.

2. The connector according to claim 1, wherein
the retainer includes a rearward protrusion protruding rearward from the body portion, and
the rearward protrusion is opposed to the rear hole surface of the mounting hole so as to be contactable therewith at the final locking position.

3. The connector according to claim 1, wherein
the mounting hole includes an insertion opening that is open on one side surface of the housing, and
an amount of exposure of the forward protrusion from the insertion opening is decreased from the temporary locking position to the final locking position.

4. The connector according to claim 3, wherein
the mounting hole is provided so as to extend from the insertion opening to an inner end surface located near another side surface of the housing, and
a window hole in communication with the mounting hole is open on the other side surface of the housing, and
the forward protrusion is disposed so as to face the window hole at the final locking position.

5. The connector according to claim 1, wherein
the retainer includes an elastically deformable lance that is opposed to the terminal from behind at each of the temporary locking position and the final locking position, and
the lance is in contact with the terminal at the final locking position.
